(19) United States
(12) Patent Application Publication
(10) Pub. No.: US 2014/0335411 A1
(43) Pub. Date: Nov. 13, 2014

(54) ETCHED SILICON STRUCTURES, METHOD OF FORMING ETCHED SILICON STRUCTURES AND USES THEREOF

(71) Applicant: Nexeon Ltd., Abingdon (GB)

(72) Inventors: Fengming Liu, Reading (GB); Yuxiong Jiang, Abingdon (GB); Mino Green, London (GB)

(21) Appl. No.: 14/367,582

(22) PCT Filed: Dec. 21, 2012
(86) PCT No.: PCT/GB2012/053241

§ 371 Date: Jun. 20, 2014

(30) Foreign Application Priority Data
Dec. 23, 2011 (GB) 1122315.3

(51) Int. Cl. H01M 4/38; C23C 18/31; C23C 18/38; H01M 4/36; C23F 1/34; C23F 1/40; H01M 4/04; C23C 18/16; C23C 18/42

(52) U.S. Cl. CPC H01M 4/386; C23C 18/1639; C23C 18/1651; C23C 18/31; C23C 18/38; C23C 18/42; C23F 1/34; C23F 1/40; H01M 4/0404; H01M 4/366; H01M 4/0492; H01M 10/052
USPC 429/218.1; 216/11; 216/95; 427/58

(57) ABSTRACT

A method of etching silicon, the method comprising the steps of: electrolessly depositing a first metal onto a silicon surface to be etched, wherein the electrolessly deposited first metal partially covers the surface of the silicon to be etched; depositing a second metal that is different from the first metal over the silicon surface and the electrolessly deposited first metal, wherein a film of the deposited second metal covers the silicon surface to be etched; removing the first metal and the second metal from regions of the film of the deposited second metal that overlie the first metal to leave the second metal partially covering the silicon surface to be etched; and etching the silicon by exposing the silicon surface to an aqueous etching composition comprising an oxidant and a source of fluoride ions.

### FIELD OF THE INVENTION

The present invention relates to methods of etching silicon, etched silicon structures, electrodes containing etched silicon structures and devices including etched silicon structures.

### BACKGROUND OF THE INVENTION

Rechargeable metal-ion batteries, for example lithium ion batteries, are extensively used in portable electronic devices such as mobile telephones and laptops, and are finding increasing application in electric or hybrid electric vehicles.

Rechargeable metal ion batteries have an anode layer (also referred to as the negative electrode); a cathode layer (also referred to as the positive electrode) capable of releasing and re-inserting metal ions; and an electrolyte between the anode and cathode layers. When the battery cell is fully charged, metal has been transported from the metal-containing cathode layer via the electrolyte into the anode layer. In the case of a graphite-based anode layer of a lithium ion battery, the lithium reacts with the graphite to create the compound LiₓC₆ (0<=x<=1). The graphite, being the electrochemically active material in the composite anode layer, has a maximum capacity of 372 mAh/g.

The use of a silicon-based active anode material, which may have a higher capacity than graphite, is also known.

U.S. Pat. No. 7,402,829 discloses etching of a silicon substrate to form an array of silicon pillars extending from the silicon substrate.

WO2009/010758 discloses the etching of silicon powder in order to make silicon material for use in lithium ion batteries. The resulting etched particles contain pillars on their surface.

Huang et al, “Metal-Assisted Chemical Etching of Silicon: A Review”, Adv. Mater. 2010, 1-24 discloses template-based metal-assisted chemical etching in which polystyrene spheres on the surface of a silicon substrate mask the underlying silicon during deposition of a silver layer by thermal evaporation, to produce a layer of silver with an ordered array of pores overlying the silicon, which was then etched. Approaches using SiO₂ spheres and using anodic aluminium oxide as a mask are also disclosed.

WO 2009/137241 discloses spin-coating silica or polystyrene nanoparticles on the surface of a silicon-containing substrate, depositing metal on top of the nanoparticles and silicon and etching the silicon. In an alternative process the polystyrene nanoparticles are replaced by Iron Oxide nanoparticles which are deposited by applying a few drops of a solution containing the dispersed particles onto the substrate and allowing the solution to evaporate. Neither of these techniques are suitable for etching a particulate silicon-comprising material.

Bang et al, “Mass production of uniform-sized nanoporous silicon nanowire anodes via block copolymer lithography”, Energy Environ. Sci. 2011, 4, 3395 discloses formation of hexagonally packed iron oxide patterns on a silicon wafer by spin-coating iron-incorporated polystyrene-block-poly(4-vinylpyridine) followed by oxygen plasma treatment. Silver particles were then electrolessly deposited on the wafer and the wafer was etched.

### SUMMARY OF THE INVENTION

In a first aspect, the invention provides a method of etching silicon, the method comprising the steps of:
electrolessly depositing a first metal onto a silicon surface to be etched, wherein the electrolessly deposited first metal partially covers the surface of the silicon to be etched;
depositing a second metal that is different from the first metal over the silicon surface and the electrolessly deposited first metal, wherein a film of the deposited second metal covers the silicon surface to be etched;
removing the first metal and the second metal from regions of the film of the deposited second metal that overlie the first metal to leave the second metal partially covering the silicon surface to be etched; and
etching the silicon by exposing the silicon surface to an aqueous etching composition comprising an oxidant and a source of fluoride ions.

Optionally, the electrolessly deposited first metal forms a plurality of islands on the silicon surface to be etched.

Optionally, the islands have a diameter in the range of 10-200 nm, optionally 20-100 nm.

Optionally, the metal islands are isolated from one another.

Optionally, at least some of the plurality of metal islands are connected by bridges of the first metal.

Optionally, at least some of the bridges are removed prior to deposition of the second metal.

Optionally, the first and second metals are independently selected from copper, silver and gold.

Optionally, the electroless deposition of the first metal comprises exposing the silicon surface to be etched to an aqueous composition comprising ions of the first metal and a source of fluoride ions or an alkali.

Optionally, the second metal is deposited by electrodeposition in an electrodeposition bath containing an electrolyte comprising a source of the second metal.

Optionally, the silicon surface is treated to remove silicon oxide prior to deposition of the second metal.

Optionally, the oxidant is selected from the group consisting of O₂; O₃; H₂O₂; and the acid or salt of NO₃⁻, S₂O₈²⁻, NO₂⁻, B₄O₇²⁻ or ClO₄⁻ or a mixture thereof, and is preferably selected from alkali metal nitrates, ammonium nitrate and mixtures thereof.

Optionally, the silicon surface is etched to form silicon pillars extending from an etched silicon surface formed by etching of the silicon surface.

Optionally, the silicon surface is etched to form porous silicon.

Optionally, the silicon is in the form of bulk silicon, optionally a silicon wafer.

Optionally, the silicon is in the form of a silicon powder, and the external surface of the particles is etched. Optionally, particles of the powder may have more than one surface (for example cuboid particles with multiple faces), of which at least one surface is etched. In the case of a powder, optionally the whole surface of the particles of the powder is anisotropically etched.

In one optional arrangement, removal of the first metal and overlying second metal is done before exposing the silicon and the second metal to the aqueous etching formulation.

In another optional arrangement, the removal of the first metal and overlying second metal and the etching of the silicon is carried out in a single step. Optionally, the single step comprises exposing the silicon carrying the first metal and second metal to the aqueous etching formulation for removal of the first metal and etching of the silicon. Optionally, the silicon is kept in a solution throughout the process of the invention, the components of the solution varying between stages as required for metal deposition or etching.

Optionally, the single step comprises exposing the silicon surface carrying the first metal and second metal to the aqueous etching formulation for removal of the first metal and etching of the silicon surface.

In a second aspect the invention provides a method of etching silicon, the method comprising the steps of:
electrolessly depositing a first metal on a silicon surface to be etched, wherein the electrolessly deposited first metal partially covers the surface of the silicon to be etched;
depositing a film of a second metal that is capable of catalysing etching of silicon over the silicon surface and over the electrolessly deposited first metal, and
etching the silicon by exposing the silicon surface to an aqueous etching composition comprising an oxidant and a source of fluoride ions.

Optionally according to the second aspect, the first metal is bismuth.

Optionally according to the second aspect, the second metal is selected from silver, copper, gold, rhodium and palladium.

Optionally according to the second aspect, the silicon is in the form of a silicon powder.

In a third aspect the invention provides etched silicon obtainable by a method according to the first or second aspect.

In a fourth aspect the invention provides an electrode comprising an active material of etched silicon according to the third aspect.

Optionally according to the fourth aspect, the electrode further comprises a conductive current collector in electrical contact with the active material.

In a fifth aspect the invention provides a method of forming an electrode according to the third aspect, the method comprising the step of depositing a slurry comprising an etched silicon powder formed according to the first aspect and at least one solvent onto a conductive substrate or current collector, and evaporating the at least one solvent.

In a sixth aspect the invention provides a method of forming an electrode according to the fourth aspect, the method comprising the step of applying the conductive current collector to etched bulk silicon.

In a seventh aspect the invention provides a rechargeable metal ion battery comprising an anode, the anode comprising an electrode according to the fourth aspect capable of inserting and releasing metal ions; a cathode formed from a metal-containing compound capable of releasing and reabsorbing the metal ions; and an electrolyte between the anode and the cathode.

Optionally according to the seventh aspect the metal ion battery is a lithium ion battery.

### DESCRIPTION OF THE DRAWINGS

The invention will now be described in more detail with reference to the drawings in which:

FIG. 1 illustrates schematically a method of etching bulk silicon according to an embodiment of the invention;

FIG. 2A illustrates schematically a plan view of the bulk silicon of FIG. 1 carrying metal islands;

FIG. 2B illustrates schematically a plan view of the bulk silicon of FIG. 1 carrying a metal layer having removed areas;

FIG. 3 illustrates schematically a plan view of bulk silicon for use in a method according to an embodiment of the invention, the bulk silicon carrying metal islands connected by bridges;

FIG. 4 illustrates schematically bulk silicon carrying metal islands and a metal layer for use in a method according to an embodiment of the invention;

FIG. 5 illustrates schematically a method of etching a silicon particle according to an embodiment of the invention; and

FIG. 6 illustrates a rechargeable metal ion battery cell according to an embodiment of the invention.

### DETAILED DESCRIPTION OF THE INVENTION

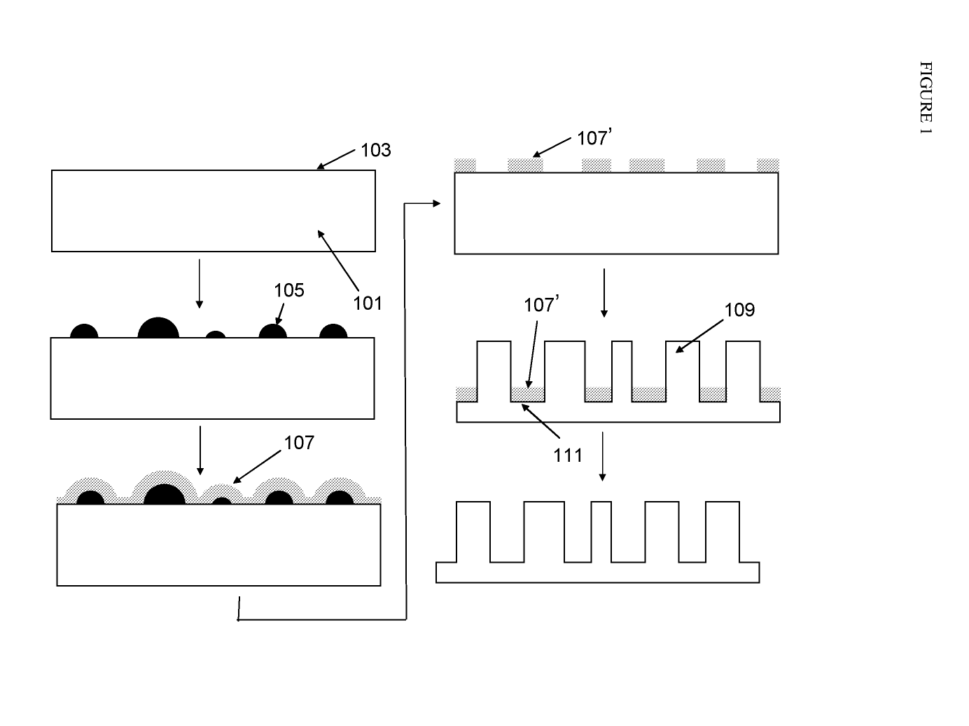

FIG. 1 illustrates a process of etching silicon according to an embodiment of the invention. In a first step, islands 105 of a first metal are deposited on a surface 103 of a silicon substrate 101. The islands 105 are formed by electroless deposition of the first metal. The islands 105 only partially cover surface 103, leaving exposed regions 107 of surface 103. The surface 103 of the silicon substrate 101 may be cleaned prior to island formation, for example to remove impurities or oxide from the substrate surface. Additionally or alternatively, the silicon surface may be subjected to an isotropic etch to smooth the silicon surface and remove surface irregularities.

A second metal is deposited over the islands 105 to form a film 107 of the second metal extending over both the islands 105 of the first metal, and over the silicon surface 103 between islands 105.

The islands 105 are then separated from surface 103 of the silicon substrate. The islands may be separated in the same step as, or before, the etching process described below.

This separation process may cause the parts of film 107 overlying the islands 105 to selectively separate from the rest of film 107 to leave a film 107′ partially covering the surface 103 of the silicon substrate 101.

Film 107′, which forms a negative template of the final etched structure, is exposed to an etching composition to etch regions of surface 103 underneath film 107′. In FIG. 1, the etching process produces pillars 109 extending from etched surface 111 however it will be appreciated that other etched structures may be formed in addition to or instead of pillars 109, for example porous silicon, in particular macroporous silicon.

The metal of film 107′ that remains after etching may be washed away or removed using acid or alkali treatment. The removed metal may be recovered and recycled.

However, if the concentration of metal per unit area of the etched silicon is low (for example, if film 107′ is sufficiently thin) then the metal may remain on the substrate 101, and a metal ion battery may be constructed using the substrate without first removing metal from film 107′. If the first metal is not removed then the substrate 101 may be annealed to form a metal silicide. If the substrate 101 is used in an electrode of a metal ion battery then the presence of the first metal, in silicide or other form, may prevent or inhibit metal ion insertion, for example lithium ion insertion, at the surface that pillars 109 extend from without significantly inhibiting metal ion insertion by the pillars 109 themselves. This may reduce or prevent damage caused by insertion and release of metal ions by silicon of the pillared silicon core.

The presence of the second metal may also enhance conductivity and connectivity of the anode, and may disrupt or reduce formation of a silicon-electrolyte interphase layer (also called a solid electrolyte interphase (SEI) layer). FIG. 1 illustrates a process in which formation of film 107′ and etching takes place on one surface of the silicon substrate, however it will be understood that more than one silicon surface may be etched by the process of the invention. For example, film 107′ may be applied to opposing surfaces of substrate 101, and both surfaces may be etched.

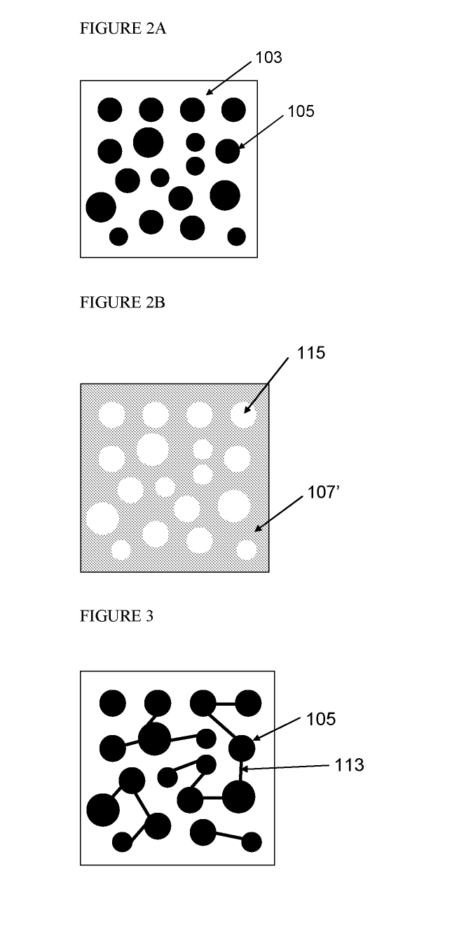

FIGS. 2A and 2B illustrate a plan view of substrate surface 103 following deposition of islands 105, and of film 107′ respectively. Film 107′ in FIG. 2B is a laterally continuous film comprising apertures 115, however it will be appreciated that there may be discontinuities in film 107′ depending on the number, size and/or arrangement of metal islands 105 on surface 103.

### Island Formation

Electroless deposition of a metal M is carried out using a solution of Mⁿ⁺ ions, wherein n is an integer of at least 1, optionally 1, 2 or 3. Electroless deposition to form islands 105 of metal M may be done by exposing silicon substrate 101 to an aqueous solution of a fluoride or an alkali, and a source of Mⁿ⁺ ions. An alkali may also be the source of Mⁿ⁺ ions. The aqueous solution may contain one or more solvents in addition to water, for example water-miscible organic solvents such as one or more alcohols. Exemplary fluorides are ammonium fluoride and hydrogen fluoride. Exemplary alkalis are hydroxides, for example alkali hydroxides. Preferably, the aqueous solution comprises HF.

Exemplary ions Mⁿ⁺ include, without limitation, Cu²⁺, Ag⁺ and Au³⁺, Pt²⁺, Ni²⁺, Bi³⁺ and Sn²⁺ for forming islands 105 of copper, silver, gold, platinum, nickel, bismuth and tin respectively. Copper, silver, bismuth or gold are preferred. Any water-soluble metal salt may be used as the source of metal ions including, without limitation, copper sulphate, copper nitrate, silver nitrate, silver perchlorate and gold cyanide. The metal ion may be the metal ion of an alkali of the electroless deposition solution. An exemplary alkali that supplies the metal ion of the metal islands is bismuth hydroxide. Bismuth islands may be formed as described in Liu et al, Applied Physics Letters 87, 2005, the contents of which are incorporated herein by reference.

In a first stage of an electroless deposition process using hydrogen fluoride, the HF reacts with the silicon according to the following half-reaction:

Si⁰+6F⁻→SiF₆²⁻+4e⁻

Electrons generated in etching of silicon cause reduction of the aqueous metal ions to elemental metal according to the following half-reaction:

Mⁿ⁺ (aq)+n e⁻→M (s)

During electroless metal island formation, the metal ions are reduced by electrons generated as shown in the first half-reaction. It will be appreciated that electroless deposition of metal M as described herein may result in some degree of etching at the silicon surface 103. This may cause the deposited metal ions to become embedded in the silicon surface, which may provide for good adhesion between the silicon surface and the deposited metal. This may be particularly advantageous for formation of metal islands on particles, where agitation of the particles may cause unwanted or premature loosening of the metal islands. Embedded islands may be used to mask underlying areas of silicon from etching as described in more detail below, rather than being removed prior to etching.

Electroless deposition may produce a random, scattered distribution of metal islands on the silicon surface. The metal islands may include isolated nanoparticle islands and islands formed by agglomeration of a plurality of nanoparticles. The islands may have a diameter in the range of 10-300 nm 10-250 nm or 10-200 nm. Optionally, the island diameter is at least 10 nm, at least 30 nm, or at least 50 nm. Optionally, island diameter is in the range 20-100 nm.

Optionally, aspect ratio (length/width) of the islands is less than 2.

An SEM image of a sample area of islands on silicon may be used to determine average aspect ratios and average diameters of islands.

Optionally, the islands are substantially circular. It will be understood that the shape, dimensions and distribution of the islands will affect the structure of the etched silicon, for example the shape, size and distribution of pillared particles.

It will be understood by the skilled person that the manner in which a metal electrolessly deposits on the silicon surface may vary between metals. For example, silver may tend to form relatively thick islands 103, and silver dendrites may be formed between these islands that may prevent formation of a substantially uniform silver film, whereas electroless deposition of copper may result in formation of copper islands that may join together relatively rapidly form a relatively thin, uniform copper film if the substrate 101 if electrodeposition is not stopped relatively rapidly following copper island formation (for example, by removal of silicon substrate 101 from the electroless deposition solution). The extent of metal island formation may be controlled by, for example, the concentration of metal ions in the solution, the length of time that the silicon remains in the solution, and/or the deposition temperature. Chartier et al, “Metal-assisted chemical etching of silicon in HF-H₂O₂”, Electrochimica Acta 53 (2008), 5509-5516 describes electroless formation of silver nanoparticles on a silicon surface, and how nanoparticle formation may be varied by deposition time, deposition temperature and/or silver solution concentration. Electroless deposition of copper and gold is described in, for example, Huang et al, “Metal-assisted electrochemical etching of silicon”, Nanotechnology 21 (2010), 465301. Electroless deposition of silver using an aqueous solution of sodium hydroxide and silver perchlorate is described in Tsujino et al, Adv. Mater. 2005, 17(8) 1045-1047.

The electroless deposition solution may be heated or cooled during electroless deposition. Temperature control may affect the rate of island formation. Temperature of the solution is optionally no less than about −5° C. Optionally, solution temperature is up to about 200° C., optionally less than 100° C., optionally up to about 90° C.

The metal islands 105 may be isolated from one another, as described above and illustrated in FIGS. 1 and 2, or may be linked by bridges 113 of the first metal extending between islands 105 as illustrated in FIG. 3. For example, electroless deposition of silver may form silver islands 105 with bridges, or dendrites, between the islands.

Where such bridges are present, the metal film 107 may be formed over the islands without removal of the bridges, or some or all of the bridges may be removed prior to formation of metal film 107. For example, silver dendrites may be washed away without removal of silver islands. Dendrites may be removed by rinsing with deionised water and/or agitation, for example ultrasonic treatment.

Metal islands 105 may be formed on one or more than one surface of the silicon substrate 101.

Removed metal islands 105 and any other removed first metal, for example removed dendrites, may be recovered and recycled.

### Overlying Metal Film Formation

The metal film 107 overlying the islands 105 and silicon of surface 103 that is not covered by islands 105 may be formed by any process known to the skilled person including, without limitation, thermal evaporation, chemical vapour deposition (CVD) sputtering and electrochemical deposition. In one arrangement the metal film 107 is formed by a method other than electroless deposition. In another arrangement the metal film 107 is formed by electroless deposition.

Electrochemical deposition of metal may be carried out in an electrodeposition bath having a working electrode of silicon substrate 101 carrying islands 105; a counter electrode; and an electrolyte containing a dissolved source of the second metal for forming the metal film 107. Exemplary electrolytes include acids. The electrolytic solution may contain the dissolved source of the second metal, and may contain one or more further materials, for example one or more salts to increase conductivity of the electrolytic solution, for example carbonates, phosphates, cyanides.

In the case of thermally evaporated or sputtered metal, the thickness of metal deposited may be controlled by the deposition time and deposition rate.

If more than one surface of silicon substrate 101 carries metal islands 105 then each of those surfaces may be provided with metal film 107. Each surface to be provided with metal film 107 may be sequentially coated with the second metal, or multiple surfaces may be coated in a single second metal deposition step. For example, CVD may take place onto a fluidized bed, which may allow multiple surfaces of silicon substrate 101 to be coated.

The film of the overlying metal may cover substantially all of the area of the surface to be etched. The film may be a continuous layer or may contain pores or voids.

The surface 103 of the silicon substrate may be treated prior to formation of metal film 107 and/or prior to electroless deposition of metal islands 105. For example, surface 103 may be treated to remove any silicon oxide or other impurities that may be present at this surface. The surface treatment may be a treatment to increase hydrophobicity or hydrophilicity of the surface and/or to form a silicon surface having —H or —OH groups at the silicon surface. An exemplary cleaning treatment is treatment with an acid, for example sulfuric acid or hydrofluoric acid. Sulfuric acid treatment may include treatment with hydrogen peroxide. Following treatment, the silicon may be washed with water, preferably ultrapure or deionised water and/or an alcohol such as ethanol. The surface treatment solution may be subjected to ultrasonic agitation during treatment.

Exemplary second metals include silver, copper, gold, rhodium, platinum and palladium.

### Island Separation

Islands 105, and overlying metal of metal film 107, may be separated from substrate 101.

The separation may be done by a lift-off method. The substrate may be agitated, for example the substrate may be subjected to ultrasonic treatment, to loosen and separate the islands 105 from the substrate.

The metal film 107 illustrated in FIG. 1 has a substantially uniform thickness formed continuously over the exposed regions of silicon surface 103 and over metal islands 105.

This film preferably has a thickness allowing regions of the metal film 107 overlying islands 105 to break away with little or no removal of metal of metal film 107 overlying exposed areas of silicon surface 103.

In other embodiments, the thickness of the film may be non-uniform, and/or the film may contain breaks between regions over islands 105 and regions over the exposed silicon surface 103.

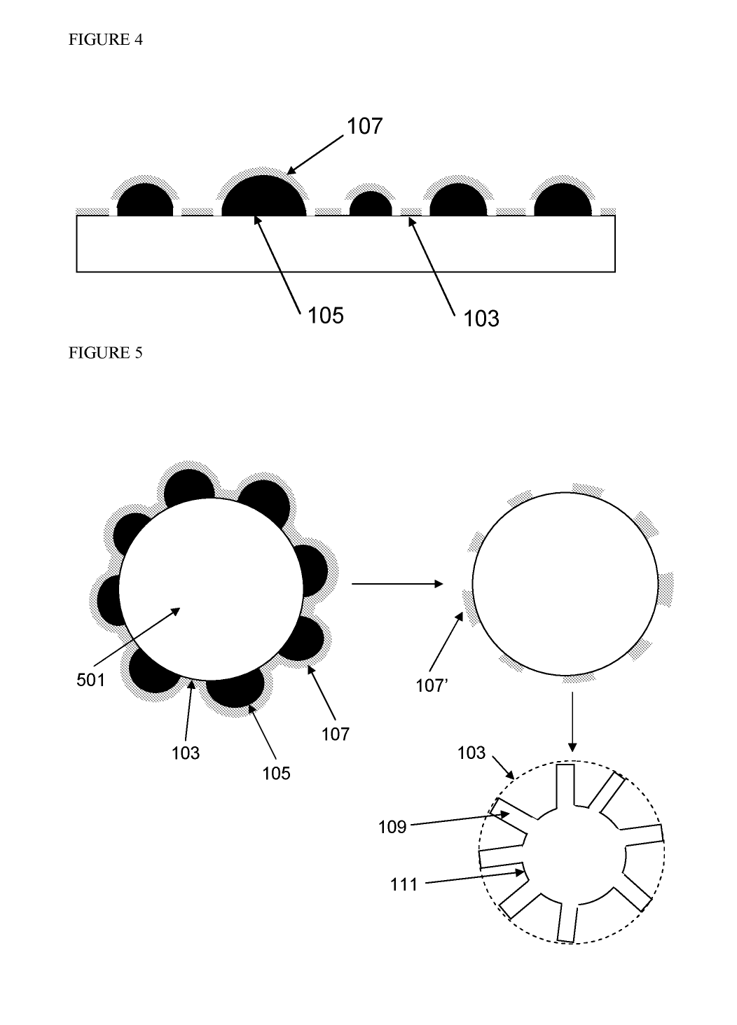

With reference to FIG. 4, breaks in the metal film 107 may exist between regions over islands 105 and regions that are not over islands 105. The thickness of the metal film between regions that are and are not over islands 105, or presence of a break in the film, may depend on the size and/or shape of metal islands 105.

The metal film 107 may be thin or may be broken if a metal island 105 forms a steep angle or overhanging angle with the surface 103 and/or if a height of the metal island 105 is substantially larger than the thickness of metal film 107 as deposited in regions where an island 105 is not present.

The metal islands 105 may be separated from the substrate 101 before etching is carried out. In another arrangement, separation of metal islands 105 and etching of film 107′ may take place in a single step, and in particular may take place in a single reaction vessel and/or in the presence of a formulation that both removes the first metal and etches the silicon. In one embodiment, the first metal may be oxidized by the oxidant used for etching without removal of the second metal.

### Etching

Etching of the silicon may take place in an etching composition including HF and an oxidant.

The oxidant may be selected from the group consisting of O₂; O₃; H₂O₂; and the acid or a salt of NO₃⁻, S₂O₈²⁻, NO₂⁻, B₄O₇²⁻ or ClO₄⁻ or a mixture thereof. Alkali metal nitrates and ammonium nitrate are preferred.

The oxidant may be provided in a concentration of at least about 0.001 M, optionally at least about 0.01 M, optionally at least about 0.1 M in an aqueous etching solution. The oxidant may be provided in a concentration of up to about 1 M.

The aqueous etching solution may contain one or more solvents in addition to water, for example water-miscible organic solvents.

HF may be provided in a concentration of at least 0.1 M, optionally about 1-10 M.

The concentration of HF and/or the concentration of the oxidant in the etching stage, may be monitored during the deposition and/or etching process, and HF and/or oxidant may be added to the etching composition if HF and/or oxidant concentration falls below a predetermined value.

The silicon may be irradiated during the deposition and etching steps. The intensity and wavelength of the light used will depend on the nature of the silicon being etched. The reaction material may be irradiated with a light source having a wavelength in the region of the bandgap of the silicon material being etched. The use of visible light is preferred. The light source may be ambient light; a lamp; or ambient light augmented by light emitted from a lamp.

The etching process may be carried out in any suitable reaction vessel, for example a vessel formed from a HF-resistant material, such as polyethylene or polypropylene or a reaction vessel lined with a HF resistant material such as a HF resistant rubber. If the silicon is irradiated then the vessel may be light-transmissive.

Etching may take place by a non-electrochemical process, i.e. a bias voltage is not applied to the silicon during etching. In this case, the second metal may function as a local electrode that catalyses HF etching of underlying silicon. Without being bound by any theory, etching may involve formation of a thin porous layer beneath the metal film, which may facilitate the transport of the HF and oxidant, followed by etching away of the porous silicon layer. Metal-assisted chemical etching of silicon is described in more detail in K. Peng et al., Angew. Chem. Int. Ed., 44 (2005), 273 7-2742; and K. Peng et al., Adv. Funct. Mater., 16 (2006), 387-394.

Substrate 101 carrying film 107′ may be etched following removal of metal islands 105. In another arrangement, substrate 101 carrying film 107, that is without prior removal of metal islands 105, may be exposed to the etching composition. Metal islands 105 may be removed by exposure to the etching formulation, followed by etching of silicon by the etching formulation.

In one embodiment, copper islands 105 are formed on the surface of substrate 101 and metal film 107 of silver or gold is formed over the copper islands and the silicon surface 103. The substrate carrying copper islands 105 and silver or gold film 107 is exposed to the etching formulation with an oxidant that is strong enough to cause in-situ removal of the copper islands 105 and etching of silicon underlying the silver or gold film remaining, following removal of the copper islands 105. The first metal may have a lower electrochemical potential than the overlying metal. Appropriate selection of the oxidant and/or oxidation conditions may allow for selective oxidation of the first metal with little or no oxidation of the overlying metal.

Areas of silicon that were underneath the metal islands 105 may provide access of the etching formulation to the silicon surface 103 for etching of the silicon in areas underneath metal film 107′ in a metal assisted etching process in which the second metal catalyses etching of underlying silicon.

In the process described above, the first metal is removed prior to etching areas of silicon underlying the remaining first metal. Preferably, the first metal is removed if the first metal is capable of catalyzing silicon etching in a metal-assisted etching step.

In an alternative embodiment, the first metal is not removed prior to etching of silicon. In this embodiment, the first metal may be a metal that does not catalyse significant silicon etching, e.g. etching to a depth of greater than about 0.5 microns, for example a metal other than silver, copper, gold, platinum and palladium. An exemplary first metal of this embodiment is bismuth. Optionally, a bismuth first metal is used in combination with an overlying layer of silver, copper, gold, platinum or palladium.

In this embodiment, the first metal masks underlying areas of silicon from etching by the second metal overlying the first metal. The overlying metal layer may be thin or may contain pores or voids to facilitate HF and oxidant access to the underlying silicon.

It will be appreciated that masking islands of non-catalysing first metal provide an etching template in the same way as islands of catalyzing first metal that are removed prior to etching, but without the need for a metal island removal step.

It may be preferable not to remove a non-catalysing first metal if the first metal islands become embedded in the silicon surface upon electroless deposition. Embedding of islands may be particularly advantageous where the first metal is deposited onto particles.

If the first metal is not removed then etching silicon to form pillars will result in formation of pillars with a bilayer of the first metal and second metal on top of the pillars.

It will be appreciated that the process as described herein provides an efficient process for etching silicon to produce structured silicon. Two or more of the steps of the process may be carried out in a single reaction vessel which provides for an efficient process and avoids the potential problem of oxidation of the silicon surface if silicon is exposed to air between stages.

Anisotropic etching may form structured silicon, in particular silicon carrying pillars or porous, preferably macroporous, silicon.

Pillars 109 may have any shape. For example, pillars may be branched or unbranched; substantially straight or bent; and of a substantially constant thickness or tapering.

With reference to FIG. 1, the pillars 109 extend outwardly from, and may be spaced apart on, etched surface 111. The pillars may be wires, nanowires, rods and columns. The pillars may be detached from the etched surface 111 to form silicon fibres. In one arrangement, substantially all pillars 111 may be spaced apart. In another arrangement, some of the pillars 111 may be clustered together. The pillars may extend as far as the surface 103 of the starting material prior to etching, or may have a length that does not reach as far as the surface 103 of the starting material.

The cross-sections of the pillars 111 may form regular shapes (e.g. circular, square or triangular) or be irregular in shape (e.g. may contain one or more concave or convex curved sides or branches or spurs extending outwards or combinations thereof).

The surface of the etched silicon may comprise both regions of porous silicon and regions with pillars. The etched silicon may also combine regions of porous and pillared silicon in an inward extending direction. That is, an outer shell region of the etched silicon may comprise pillared silicon whilst the inner region comprises porous silicon and vice versa.

Pores may extend at least 0.5 microns into the silicon from silicon surface 203, optionally at least 1 micron, optionally at least 2 microns. The pores may have a diameter of at least 100 nm, optionally at least 300 nm, optionally at least 0.5 microns. The pores may extend inwards perpendicular to the silicon surface or may extend inwards at any intermediate angle. Not all pores may extend in the same direction, instead the plurality of pores may extend in a plurality of directions. The direction in which the pores extend inwards may change partway down. Two or more pores may join to form an irregular network of pores below the surface of the silicon.

Pillars may be formed by etching the silicon surface to a depth of more than 0.5 microns, optionally at least 1 micron, optionally at least 2 microns, optionally more than 10 microns. Optionally, the pillars are formed by etching the silicon surface to a depth in the range of 2-10 microns.

The pillars may have a diameter or thickness in the range of about 0.02 to 0.70 μm, e.g. 0.1 to 0.5 μm, for example 0.1 to 0.25 μm, preferably in the range 0.04 to 0.50 μm. The pillars may have an aspect ratio (defined as the height of the pillar divided by the average thickness or diameter of the pillar at its base) in the range 5:1 to 100:1, preferably in the range 10:1 to 100:1. The pillars may be substantially circular in cross-section but they need not be. Where the pillars have irregular cross-sections comprising a plurality of extended sections with changing direction and/or with branches or spurs then the average thickness of the plurality of such section is used in the calculation of the aspect ratio. The pillars may extend outwards from the silicon in any direction and may comprise kinks or changes in direction along their length.

The surfaces of pores or pillars may be relatively smooth or they may be rough. The surfaces may be pitted or comprise pores or voids with diameters less than 50 nm. The pillar structures may be mesoporous or microporous.

The porosity of the etched silicon may be defined as the percentage ratio of the total volume of the void space or pores introduced into the etched silicon to the volume of the silicon before etching. A higher porosity may provide a higher surface area which may increase the reactivity of the silicon in a device, for example in electrochemical cells, sensors, detectors, filters etc. or it may provide a larger volume for containing ingredients or active agents in medical or consumer product compositions. However, if the porosity is too large the structural integrity (or mechanical strength) of the silicon may be reduced and for example, in devices such as a lithium ion battery, the volume of electrochemically active silicon material is reduced. The porosity of the etched silicon may be at least 5%, optionally at least 10%. Preferably it is at least 20%. The porosity may be less than 90%, optionally less than 80%. Preferably it is no more than 75%.

Dimensions of pores and pillars may be measured using optical methods, for example scanning electron microscopy. Porosity may be measured using known gas or mercury porosimetry techniques or by measuring the mass of the silicon material before and after etching.

### Silicon Starting Material

The silicon to be etched may be undoped, n-doped, p-doped or a mixture thereof. Preferably, the silicon is n- or p-doped. Examples of p-type dopants for silicon include B, Al, In, Mg, Zn, Cd and Hg. Examples of n-type dopants for silicon include P, As, Sb and C. Dopants such as germanium and silver can also be used.

The silicon may be pure silicon or may be an alloy or other mixture of silicon and one or more other materials. The silicon may have a purity of at least 90.00 wt %, optionally at least 99 wt %. Optionally the silicon purity may be less than 99.9999 wt %. The silicon may be metallurgical grade silicon.

The silicon may have a resistivity of at least 0.005 Ω.cm, optionally at least 0.01 Ω.cm, optionally at least 1 Ω.cm. The silicon resistivity may be up to about 100 Ω.cm.

The silicon surface is optionally selected from (100) and (111) silicon.

Etching may be carried out on, for example, bulk silicon as illustrated in FIG. 1.

Etching may also be carried out on a silicon powder.

The silicon to be etched may be supported on a surface of another material. For example, a particle to be etched may have a non-silicon core of a conductive material, for example a graphite core, with a silicon shell of a thickness sufficient to allow etching of the shell to form silicon pillars extending from an etched surface of the shell.

The material to be etched may have more than one surface, for example opposing surfaces of a silicon wafer or surfaces of cuboid silicon particles, and one or more surfaces of a material may be etched.

FIG. 5 illustrates a process of etching a silicon particle 501 of a silicon powder to form a pillared particle.

Metal islands 105 are deposited on surface 103 of the particle 501 by electroless deposition as described above. Electroless formation of nanoparticles on the surface of silver particles is described in, for example, Bang et al, “Scalable approach to multi-dimensional bulk Si anodes via metal-assisted chemical etching”, Energy Environ. Sci. DOI: 10.1039/c1ee02310a.

A film 107 of a second metal is formed over the surface 103 and metal islands 105. If film 107 is formed by a method such as thermal evaporation or sputtering then film 107 may be formed only on surface 103 that is exposed to the second metal source. Substantially all of the particle 501 may be covered with film 107 by a method such as electrodeposition or CVD, for example electrodeposition or CVD in which the silicon particles form a fluidized bed. Agitation of the fluidized bed may cause substantially all of the particle surface to be coated. The film 107 illustrated in FIG. 5 is continuous over the islands 105 and exposed regions of the silicon surface 103, however it will be appreciated that there may be breaks in the film 107 as described with reference to FIG. 4.

The metal islands 105 and overlying metal of film 107 are removed to form a particle having metal film 107′ which is then exposed to an etching formulation as described above to form a particle carrying pillars 109 on etched surface 111. The pillars may have a length extending to the now etched surfaced of starting material 103, shown in FIG. 5 as a dotted line around the pillared particle. Some or all pillars may be etched such that they do not extend as far as the surface 103 of the starting material.

Exemplary bulk silicon structures include silicon sheets such as silicon wafers or of metallurgical grade silicon, and silicon sheets or chips formed by breaking a silicon wafer into smaller pieces, or by breaking other forms of bulk silicon into sheets or flakes. Powder particles of silicon may be formed from a silicon source such as metallurgical grade silicon by any process known to the skilled person, for example by grinding or jetmilling bulk silicon to a desired size. Suitable example silicon powders are available as “Silgrain™” from Elkem of Norway.

Where used, bulk silicon such as a silicon wafer may have first and second opposing surfaces, each surface having an area of at least 0.25 cm², optionally at least 0.5 cm², optionally at least 1 cm². Each surface may be substantially planar. Bulk silicon may have a thickness of more than 0.5 micron, optionally more than 1 micron, optionally more than 10 microns, optionally more than 100 microns, optionally in the range of about 100-1000 microns.

Where used, particles may be in the form of flakes or wires, or cuboid, substantially spherical or spheroid particles. They may be multifaceted or may have substantially continuous curved surfaces. Non-spherical core particles may have an aspect ratio of at least 1.5:1, optionally at least 2:1.

The particles may have a size with a largest dimension up to about 100 μm, preferably less than 50 μm, more preferably less than 30 μm.

The particles may have at least one smallest dimension less than one micron. Preferably the smallest dimension is at least 0.5 microns.

Particle sizes may be measured using optical methods, for example scanning electron microscopy.

In a composition containing a plurality of particles, for example a powder, preferably at least 20%, more preferably at least 50% of the particles have smallest dimensions in the ranges described above. Particle size distribution may be measured using laser diffraction methods or optical digital imaging methods.

### Battery Formation

Etched silicon formed as described herein may be used to form the anode of a rechargeable metal ion battery.

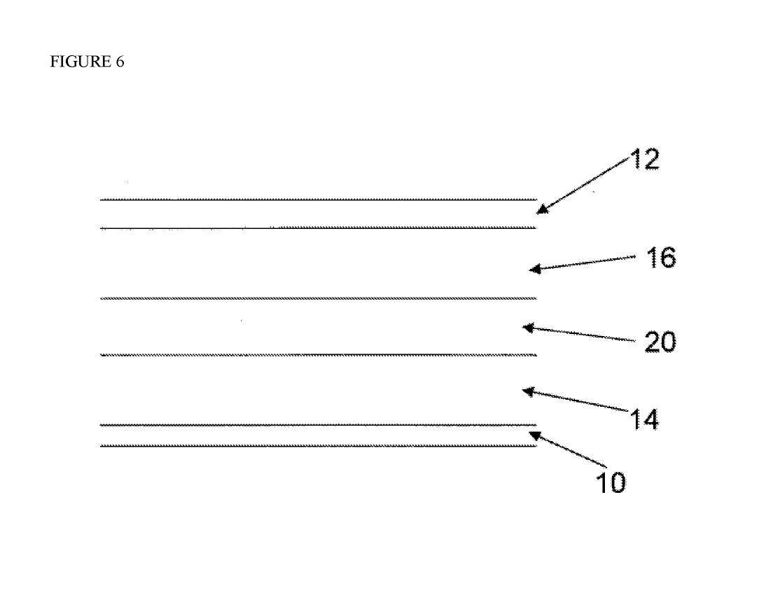

The structure of a rechargeable metal ion battery cell is shown in FIG. 6, which is not drawn to any scale. The battery cell includes a single cell but may also include more than one cell. The battery is preferably a lithium ion battery, but may be a battery of another metal ion, for example sodium ion and magnesium ion.

The battery cell comprises a current collector for the anode 10, for example copper, and a current collector for the cathode 12, for example aluminium, which are both externally connectable to a load or to a recharging source as appropriate. An anode layer containing active silicon 14 overlays the current collector 10 and a lithium containing metal oxide-based composite cathode layer 16 overlays the current collector 12 (for the avoidance of any doubt, the terms “anode” and “cathode” as used herein are used in the sense that the battery is placed across a load—in this sense the negative electrode is referred to as the anode and the positive electrode is referred to as the cathode. “Active material” or “electroactive material” as used herein means a material which is able to insert into its structure, and release therefrom, metal ions such as lithium, sodium, potassium, calcium or magnesium during the respective charging phase and discharging phase of a battery. Preferably the material is able to insert and release lithium).

A liquid electrolyte is provided between the anode and the cathode. In the example of FIG. 1, a porous plastic spacer or separator 20 is provided between the anode layer 14 and the lithium containing cathode layer 16, and a liquid electrolyte material is dispersed within the porous plastic spacer or separator 20, the anode layer 14 and the composite cathode layer 16. The porous plastic spacer or separator 20 may be replaced by a polymer electrolyte material and in such cases the polymer electrolyte material is present within both the anode layer 14 and the composite cathode layer 16. The polymer electrolyte material can be a solid polymer electrolyte or a gel-type polymer electrolyte.

The electrolyte is suitably a non-aqueous electrolyte containing a lithium salt and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylenes carbonate, dimethyl carbonate, diethyl carbonate, gamma butyro lactone, 1,2-dimethoxy ethane, 2-methyl tetrahydrofuran, dimethylsulphoxide, 1,3-dioxolane, formamide, dimethylformamide, acetonitrile, nitromethane, methylformate, methyl acetate, phosphoric acid trimester, trimethoxy methane, sulpholane, methyl sulpholane and 1,3-dimethyl-2-imidazolidione.

Examples of organic solid electrolytes include polyethylene derivatives polyethyleneoxide derivatives, polypropylene oxide derivatives, phosphoric acid ester polymers, polyester sulphide, polyvinyl alcohols, polyvinylidine fluoride and polymers containing ionic dissociation groups.

Examples of inorganic solid electrolytes include nitrides, halides and sulphides of lithium salts such as Li₅NI₂, Li₃N, LiI, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiBC₄O₈, LiPF₆, LiCF₃SO₃, LiAsF₆, LiSbF₆, LiAlCl₄, CH₃SO₃Li and CF₃SO₃Li.

Where the electrolyte is a non-aqueous organic solution, the battery is provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

When the battery cell is fully charged, lithium has been transported from the lithium containing metal oxide cathode layer 16 via the electrolyte into the anode layer 14.

In the case where bulk silicon is etched, an anode current collector may be formed on one side of the bulk silicon and another side of the bulk silicon having an etched surface may come into contact with the electrolyte of the battery. The current collector may be a metal foil, for example copper, nickel or aluminium, or a non-metallic current collector such as carbon paper.

In the case where the silicon is in the form of an etched powder, a slurry comprising the etched powder and one or more solvents may be deposited over an anode current collector to form an anode layer. The slurry may further comprise a binder material, for example polyimide, polyacrylic acid (PAA) and alkali metal salts thereof, polyvinylalchol (PVA) and polyvinylidene fluoride (PVDF), sodium carboxymethylcellulose (Na-CMC) and optionally, non-active conductive additives, for example carbon black, carbon fibres, ketjen black or carbon nanotubes. In addition to providing the silicon powder to act as an active material in the battery, one or more further active materials may also be provided in the slurry. Exemplary further active materials include active forms of carbon such as graphite or graphene. Active graphite may provide for a larger number of charge/discharge cycles without significant loss of capacity than active silicon, whereas silicon may provide for a higher capacity than graphite. Accordingly, an electrode composition comprising a silicon-containing active material and a graphite active material may provide a lithium ion battery with the advantages of both high capacity and a large number of charge/discharge cycles. The slurry may be deposited on a current collector, which may be as described above. Further treatments may be done as required, for example to directly bond the silicon particles to each other and/or to the current collector. Binder material or other coatings may also be applied to the surface of the composite electrode layer after initial formation.

Examples of suitable cathode materials include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

Etched silicon structures comprising pores or elongated pillar-like structures may be used in a wide range of applications other than rechargeable metal ion batteries such as fuel cells, thermal batteries, photovoltaic devices such as solar cells, filters, sensors, electrical and thermal capacitors, microfluidic devices, gas/vapour sensors, thermal or dielectric insulating devices, devices for controlling or modifying the transmission, absorption or reflectance of light or other forms of electromagnetic radiation, chromatography or wound dressings.

Porous silicon particles may also be used for the storage, controlled delivery or timed release of ingredients or active agents in consumer care products including oral hygiene and cosmetic products, food or other nutritional products, or medical products including pharmaceutical products that deliver drugs internally or externally to humans or animals.

Etched silicon may also form architectured conducting or semiconducting components of electronic circuitry.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A method of etching silicon, the method comprising the steps of:
electrolessly depositing a first metal onto a silicon surface to be etched, wherein the electrolessly deposited first metal partially covers the surface of the silicon to be etched;
depositing a second metal that is different from the first metal over the silicon surface and the electrolessly deposited first metal, wherein a film of the deposited second metal covers the silicon surface to be etched;
removing the first metal and the second metal from regions of the film of the deposited second metal that overlie the first metal to leave the second metal partially covering the silicon surface to be etched; and
etching the silicon by exposing the silicon surface to an aqueous etching composition comprising an oxidant and a source of fluoride ions.

2. A method according to claim 1 wherein the electrolessly deposited first metal forms a plurality of islands on the silicon surface to be etched.

3. A method according to claim 2 wherein the islands have a diameter in the range of 10-200 nm, optionally 20-100 nm.

4. A method according to claim 2, wherein
(i) the metal islands are isolated from one another; or
(ii) at least some of the plurality of metal islands are connected by bridges of the first metal; or
(iii) at least some of the plurality of metal islands are connected by bridges of the first metal, wherein at least some of the bridges are removed prior to deposition of the second metal.

5-6. (canceled)

7. A method according to claim 1 wherein
(i) the first and second metals are independently selected from copper, silver and gold; and/or
(ii) the electroless deposition of the first metal comprises exposing the silicon surface to be etched to an aqueous composition comprising ions of the first metal and a source of fluoride ions or an alkali; and/or
(iii) the second metal is deposited by electrodeposition in an electrodeposition bath containing an electrolyte comprising a source of the second metal; and/or
(iv) the silicon surface is treated to remove silicon oxide prior to deposition of the second metal; and/or
(v) the oxidant is selected form the group consisting of O₂; O₃, H₂O₂; and the acid or salt of NO₃⁻, S₂O₈²⁻, NO₂⁻, B₄O₇²⁻ or ClO₄⁻ or a mixture thereof, and is preferably selected from alkali metal nitrates, ammonium nitrate and mixtures thereof.

8-11. (canceled)

12. The method according to claim 1 wherein
(i) the silicon surface is etched to form silicon pillars extending from an etched silicon surface formed by etching of the silicon surface; or
(ii) the silicon surface is etched to form porous silicon.

13. (canceled)

14. A method according to claim 1 wherein the silicon is in the form of bulk silicon, optionally a silicon wafer.

15. A method according to claim 1 wherein the silicon is in the form of a silicon powder.

16. A method according to claim 1 wherein
(i) a removal of the first metal and overlying second metal is done before exposing the silicon surface and the second metal to the aqueous etching formulation; or
(ii) the removal of the first metal and overlying second metal and the etching of the silicon surface is carried out in a single step; or
(iii) the removal of the first metal and overlying second metal and the etching of the silicon surface is carried out in a single step, wherein the single step comprises exposing the silicon surface carrying the first metal and second metal to the aqueous etching formulation for removal of the first metal and etching of the silicon surface.

17-18. (canceled)

19. A method of etching silicon, the method comprising the steps of:
electrolessly depositing a first metal on a silicon surface to be etched, wherein the electrolessly deposited first metal partially covers the surface of the silicon to be etched;
depositing a film of a second metal that is capable of catalysing etching of silicon over the silicon surface and over the electrolessly deposited first metal, and
etching the silicon by exposing the silicon surface to an aqueous etching composition comprising an oxidant and a source of fluoride ions.

20. A method according to claim 19 wherein
(i) the first metal is bismuth; and/or
(ii) the second metal is selected from silver, copper, gold, rhodium, platinum and palladium; and/or
(iii) the silicon is in the form of a silicon powder.

21-22. (canceled)

23. Etched silicon obtainable by a method according to claim 1.

24. An electrode comprising an active material of etched silicon according to claim 23, optionally wherein the electrode further comprises a conductive current collector in electrical contact with the active material.

25. (canceled)

26. A method of forming an electrode comprising an active material of etched silicon and a conductive current collector in electrical contact with the active material, the method comprising the step of depositing a slurry comprising an etched silicon powder formed according to the method of claim 1 and at least one solvent onto a conductive substrate or current collector, and evaporating the at least one solvent.

27. A method of forming an electrode comprising an active material of etched silicon and a conductive current collector in electrical contact with the active material, the method comprising the step of applying the conductive current collector to etched bulk silicon formed according to the method of claim 14.

28. A rechargeable metal ion battery comprising an anode, the anode comprising an electrode according to claim 24 capable of inserting and releasing metal ions; a cathode formed from a metal-containing compound capable of releasing and reabsorbing the metal ions; and an electrolyte between the anode and the cathode, optionally wherein the metal ion battery is a lithium ion battery.

29. (canceled)

30. Etched silicon obtainable by a method according to claim 19.

31. An electrode comprising an active material of etched silicon according to claim 30, optionally wherein the electrode further comprises a conductive current collector in electrical contact with the active material.

32. A method of forming an electrode comprising an active material of etched silicon and a conductive current collector in electrical contact with the active material, the method comprising the step of depositing a slurry comprising an etched silicon powder formed according to the method of claim 19 and at least one solvent onto a conductive substrate or current collector, and evaporating the at least one solvent.

33. A rechargeable metal ion battery comprising an anode, the anode comprising an electrode according to claim 31 capable of inserting and releasing metal ions; a cathode formed from a metal-containing compound capable of releasing and reabsorbing the metal ions; and an electrolyte between the anode and the cathode, optionally wherein the metal ion battery is a lithium ion battery.
